(19) United States
(12) Patent Application Publication
(10) Pub. No.: US 2022/0286522 A1
(43) Pub. Date: Sep. 8, 2022

(54) SERVER, DATA COLLECTION SYSTEM, RECORDING MEDIUM, AND DATA COLLECTION METHOD

(71) Applicant: Toyota Jidosha Kabushiki Kaisha, Toyota-shi (JP)

(72) Inventor: Naoto Okino, Tokyo (JP)

(73) Assignee: Toyota Jidosha Kabushiki Kaisha, Toyota-shi (JP)

(21) Appl. No.: 17/647,100

(22) Filed: Jan. 5, 2022

(30) Foreign Application Priority Data
Mar. 2, 2021 (JP) 2021-032912

(51) Int. Cl. H04L 67/00; G06K 9/62; G06V 20/56; H04L 67/12; G07C 5/00; G05D 1/00

(52) U.S. Cl. CPC H04L 67/34; G06K 9/6201; G06V 20/56; H04L 67/12; G07C 5/008; G05D 1/0011; B60W 2050/0083

(57) ABSTRACT

A server includes a processor to: generate vehicle condition information for one or more target vehicles to be subjected to data collection based on any condition; and output control command information for causing a matching vehicle that matches the vehicle condition information among the one or more target vehicles to execute predetermined processing.

### CROSS-REFERENCE TO RELATED APPLICATION(S)

The present application claims priority to and incorporates by reference the entire contents of Japanese Patent Application No. 2021-032912 filed in Japan on Mar. 2, 2021.

### BACKGROUND

The present disclosure relates to a server, a data collection system, a recording medium, and a data collection method.

Japanese Laid-open Patent Publication No. 2018-055191 discloses a technique of determining a data collection condition including a collection frequency of probe data in a vehicle, distributing the data collection condition to each of a plurality of vehicles, receiving probe data sent from each vehicle, and accumulating the probe data in a storage device in order to collect, in a server, data acquired by the vehicles at an appropriate data collection frequency.

### SUMMARY

There is a need for providing a server, a data collection system, a recording medium, and a data collection method that can flexibly cope with diversification of services to be provided.

According to an embodiment, a server includes a processor to: generate vehicle condition information for one or more target vehicles to be subjected to data collection based on any condition; and output control command information for causing a matching vehicle that matches the vehicle condition information among the one or more target vehicles to execute predetermined processing.

According to an embodiment, a data collection system includes: a plurality of vehicles each including a sensor group for detecting vehicle data related to at least a vehicle state; and a server including a processor configured to generate vehicle condition information for one or more target vehicles to be subjected to data collection based on any condition; and output control command information for causing a matching vehicle that matches the vehicle condition information among the one or more target vehicles to execute predetermined processing.

According to an embodiment, a non-transitory computer-readable recording medium stores a program causing a processor to: generate vehicle condition information for one or more target vehicles to be subjected to data collection based on any condition; and output control command information for causing a matching vehicle that matches the vehicle condition information among the one or more target vehicles to execute predetermined processing.

According to an embodiment, a data collection method performed by a processor, includes: generating vehicle condition information for one or more target vehicles to be subjected to data collection based on any condition; and outputting control command information for causing a matching vehicle that matches the vehicle condition information among the one or more target vehicles to execute predetermined processing.

### BRIEF DESCRIPTION OF THE DRAWINGS

FIG. 1 is a schematic diagram illustrating a schematic configuration of a data collection system according to an embodiment;

FIG. 2 is a block diagram illustrating a functional configuration of a vehicle according to the embodiment;

FIG. 3 is a block diagram illustrating a functional configuration of an edge server according to the embodiment;

FIG. 4 is a block diagram illustrating a functional configuration of a center server according to the embodiment;

FIG. 5 is a diagram illustrating an outline of distribution processing performed by the center server according to the embodiment to distribute vehicle condition information to all vehicles;

FIG. 6 is a diagram illustrating an outline of distribution processing performed by the center server according to the embodiment to distribute the vehicle condition information to a vehicle that meets a specific condition;

FIG. 7 is a diagram illustrating an outline of distribution processing performed by the center server according to the embodiment to distribute control command information to the vehicle that matches the vehicle condition information;

FIG. 8 is a flowchart illustrating an outline of processing executed by the data collection system according to the embodiment;

FIG. 9 illustrates an outline of distribution processing performed by the center server according to the embodiment to distribute, to the plurality of vehicles, pieces of control command information from a plurality of services;

FIG. 10 is a diagram illustrating an outline of data processing from each of the vehicles 10 according to the embodiment to a generation unit of the center server; and

FIG. 11 is a diagram illustrating an outline of data processing performed when the communication state of the vehicle according to the embodiment is switched from the online state to the offline state and then switched back to the online state.

### DETAILED DESCRIPTION

In recent years, with diversification of services, required conditions for vehicle data that is needed, a data format, a trigger of data collection timing, a real-time property, and the like are different for services. Therefore, in such a case, it is necessary to change a specification of an electronic control unit (ECU) of the vehicle and a processing flow in the sensor for each service to be provided.

Hereinafter, a data collection system according to an embodiment of the present disclosure will be described with reference to the drawings. Note that the present disclosure is not limited to the following exemplary embodiment. In the following description, the same parts are denoted by the same reference signs.

Outline of Data Collection System

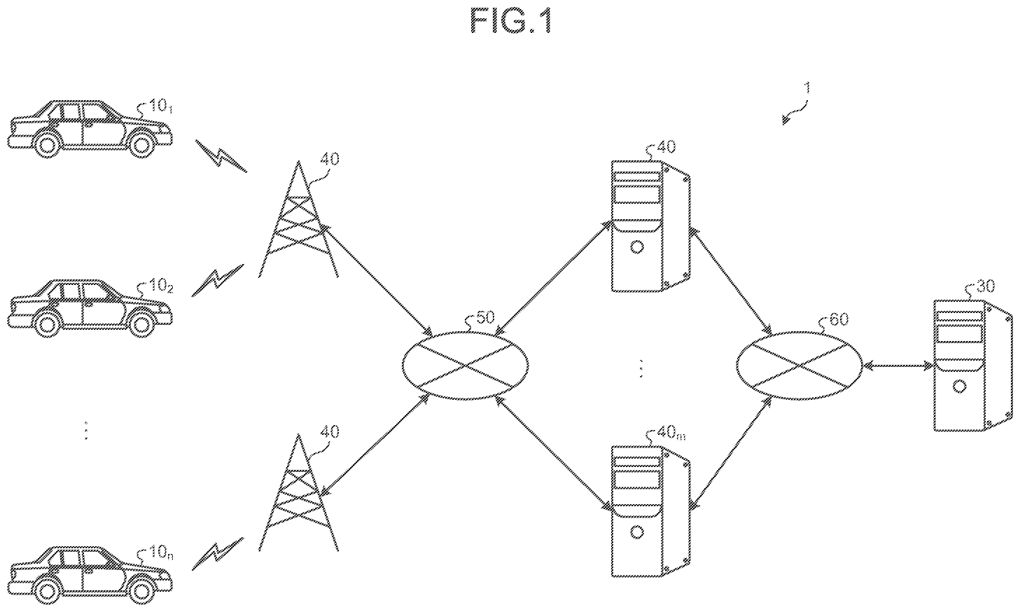

FIG. 1 is a schematic diagram illustrating a schematic configuration of a data collection system. A data collection system 1 illustrated in FIG. 1 includes a plurality of vehicles 10₁ to 10ₙ (n=an integer of 3 or more) (hereinafter, when any one of the plurality of vehicles 10₁ to 10ₙ is referred to, it is simply referred to as the “vehicle 10”), a plurality of edge servers 20₁ to 20ₘ (m=2 or more) (hereinafter, when any one of the plurality of edge servers 20₁ to 20ₘ is referred to, it is simply referred to as the “edge server 20”), and a center server 30. The vehicle 10 and the edge server 20 are configured to be able to communicate with each other via a line network including a base station 40, a network 50, and the like such as a mobile phone line network, for example. Furthermore, the edge server 20 and the center server 30 are configured to be able to communicate with each other via a network 60 such as the Internet line network, for example.

The data collection system 1 is formed using, for example, a Publish/Subscribe message model. Here, the Publish/Subscribe message model is one of data transmission methods that is used in a case where there are a plurality of data publishes (the center servers 30) and a plurality of data subscribers (the vehicles 10), and that allows any combination of the data publishers and the data subscribers to send and receive data via a relay server, a relay system (for example, edge server 20), or the like. Specifically, the data collection system 1 functions as a publisher on the sending side in which the center server 30 generates and sends a message in accordance with an input from an operator. Further, the data collection system 1 functions as a subscriber on the receiving side in which the vehicle 10 receives the message. The center server 30 registers (Publish) a message generated based on any condition specified and input by an operator, specifically, vehicle condition information as a topic in, for example, a message queue telemetry transport broker (MQTT_Broker). Thereafter, the message registered in MQTT_Broker is distributed to one or more of the vehicles 10 that have applied for subscription of the topic (Subscribe). Subsequently, the vehicle 10 matching the message (vehicle condition information) distributes matching information indicating that the vehicle matches the vehicle condition information to the center server 30 (Subscribe). Thereafter, the center server 30 outputs, to the vehicle 10, control command information for causing the vehicle 10 matching the vehicle condition information to perform predetermined processing. Here, based on any condition, the vehicle condition information includes at least one of vehicle type information, model information, make information, or position information of a target vehicle, presence or absence of a function to be subjected to predetermined processing (for example, a lane deviation warning function is installed), target collection data, or a data format. The target collection information includes specific data content, data format, and the like. The specific data content relates to various types of data regarding the vehicle 10 such as acceleration data every 3 minutes, moving image data of an in-vehicle camera or the like every 1 hour, type data of application software, and the like. The data format is, for example, a file format such as MPEG-4, JPEG. The control command information is a control command of processing content to be executed on the vehicle 10 side. Specifically, the control command information includes a control command for causing execution of processing of extracting moving image data at predetermined time intervals (for example, at intervals of 3 minutes) and outputting the moving image data to the center server 30, a control command for causing execution of processing of extracting acceleration information at predetermined time intervals and outputting the acceleration information to the center server 30, or the like.

Functional Configuration of Vehicle

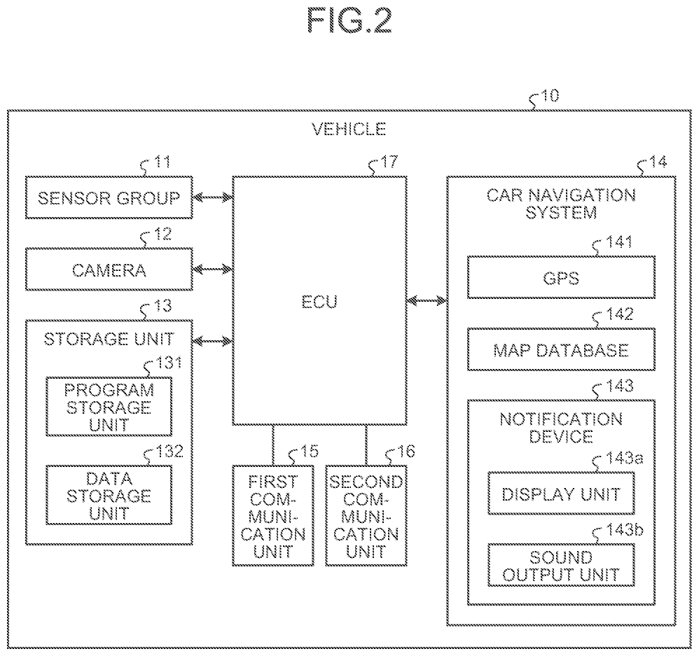

First, a functional configuration of the vehicle 10 will be described. FIG. 2 is a block diagram illustrating a functional configuration of the vehicle 10. The vehicle 10 illustrated in FIG. 2 includes a sensor group 11, a camera 12, a storage unit 13, a car navigation system 14, a first communication unit 15, a second communication unit 16, and an electronic control unit (ECU) 17. Note that, in the following description, the vehicle 10 will be described as an automobile, but the present disclosure is not limited thereto, and may be applied to, for example, a bus, a truck, a motorcycle, an electric motorcycle such as a bicycle or a kickboard including a motor or the like, a tricycle, a ship, a drone, or the like.

The sensor group 11 includes a vehicle speed sensor, an accelerator sensor, an acceleration sensor, an angular velocity sensor, a brake sensor, and the like. The sensor group 11 detects vehicle data related to the vehicle state of the vehicle 10 and outputs the detection result to the ECU 17. Specifically, the sensor group 11 detects a vehicle speed during traveling of the vehicle 10, an operation amount of the accelerator pedal provided in the vehicle 10, an operation amount of the brake pedal provided in the vehicle 10, an acceleration of the vehicle 10, an angular velocity of the vehicle 10, and the like, and outputs the detection result to the ECU 17.

The camera 12 includes one or more lenses and an image sensor such as a charge coupled device (CCD) sensor or a complementary metal oxide semiconductor (CMOS) sensor that captures a subject image formed by light condensed by the lenses. The camera 12 is provided on the front, rear, or side of the vehicle 10. The camera 12 generates image data and moving image data by capturing an image of at least one of the front, rear, or side of the vehicle 10, and outputs the image data and the moving image data to the ECU 17.

The storage unit 13 includes a hard disk drive (HDD), a solid state drive (SSD), a dynamic random access memory (DRAM), a read only memory (ROM), a recording medium, or the like. The storage unit 13 stores various types of information regarding the vehicle 10. The storage unit 13 includes a program storage unit 131 and a data storage unit 132. The program storage unit 131 stores various programs executed by the vehicle 10. The data storage unit 132 stores data being processed in the vehicle 10, host vehicle information for identifying the host vehicle, and various types of data. Here, the host vehicle information includes vehicle type information, model information, identification information, performance information and a model of the camera 12, and the like. The host vehicle information may include state information regarding the host vehicle such as current position information and a vehicle speed of the host vehicle.

The car navigation system 14 includes a global positioning system (GPS) 141, a map database 142, and a notification device 143.

The GPS 141 receives a signal from a GPS satellite and calculates the position of the vehicle 10 based on the received signal. The GPS 141 includes a GPS receiving sensor or the like.

The map database 142 stores various types of map data. The map database 142 includes a recording medium such as an HDD, or an SSD.

The notification device 143 includes a display unit 143a that displays an image, a video, and character information, and a sound output unit 143b that generates a sound such as a voice or a warning sound. The display unit 143a includes a display panel such as liquid crystal, organic electro luminescence (EL), or the like. The sound output unit 143b includes a speaker or the like.

The car navigation system 14 configured as described above superimposes the current position of the vehicle 10 acquired by the GPS 141 on the map data stored in the map database 142 under the control of the ECU 17, thereby notifying a passenger of information including the road on which the vehicle 10 is currently traveling, the route to the destination, and the like via the display unit 143a and the sound output unit 143b.

Under the control of the ECU 17, the first communication unit 15 sends various types of information and receives various types of information according to the communication standard of the mobile phone line via the base station 40 and the network 50. The first communication unit 15 includes a communication module capable of wireless communication or the like.

Under the control of the ECU 17, the second communication unit 16 sends various types of information and receives various types of information according to a communication standard different from the communication standard of the first communication unit 15 such as Wi-Fi (registered trademark) or Bluetooth (registered trademark) via the base station 40 and the network 50. Alternatively, the second communication unit 16 sends various types of information to another vehicle 10 or a mobile terminal possessed by a passenger in the vehicle 10, and receives various types of information from another vehicle 10 or a mobile terminal possessed by a passenger in the vehicle 10. The second communication unit 16 includes a communication module or the like.

The ECU 17 controls operation of each unit included in the vehicle 10. The ECU 17 includes a memory and a processor having hardware such as a central processing unit (CPU).

Functional Configuration of Edge Server

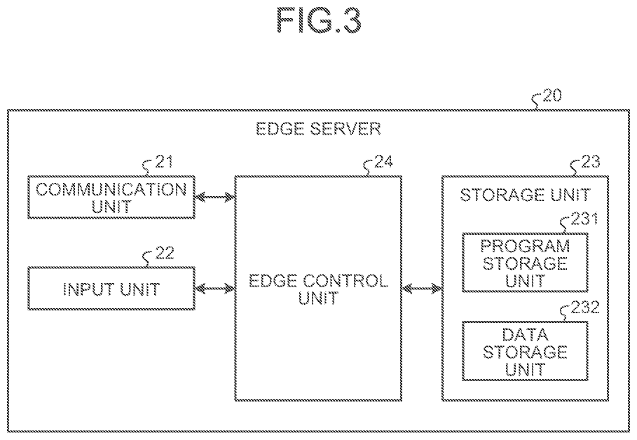

Next, a functional configuration of the edge server 20 will be described. FIG. 3 is a block diagram illustrating a functional configuration of the edge server 20. The edge server 20 illustrated in FIG. 3 includes a communication unit 21, an input unit 22, a storage unit 23, and an edge control unit 24. Note that, in the following description, as the edge server 20, a mobile terminal and a tablet terminal possessed by a user, cloud computing, or the like is assumed, but the edge server is not limited thereto. Further, the edge server 20 communicates with the vehicle 10 bidirectionally to perform high-load processing in the vehicle 10 such as image processing for detecting a subject, an object, or the like on moving image data, or the like, in place of the ECU 17 of the vehicle 10.

Under the control of the edge control unit 24, the communication unit 21 sends various types of information to the vehicle 10 or the center server 30, and receives various types of information from the vehicle 10 or the center server 30 according to a predetermined communication standard via the base station 40 and the network 50 or the network 60. The communication unit 21 includes a communication module capable of wireless communication or the like. The input unit 22 includes, for example, a keyboard, a touch panel, a mouse, or the like. The input unit 22 receives inputs of various operations from a user, and outputs information corresponding to the received various operations to the edge control unit 24.

The storage unit 23 includes a recording medium such as a ROM, a RAM, an HDD, or an SSD. The storage unit 23 stores various programs executed by the edge server 20 including a program for the edge server 20 to function as an MQTT_Broker and data being processed.

The edge control unit 24 controls the operation of each unit included in the edge server 20. The edge control unit 24 includes a memory and a processor having hardware such as a CPU.

Functional Configuration of Center Server

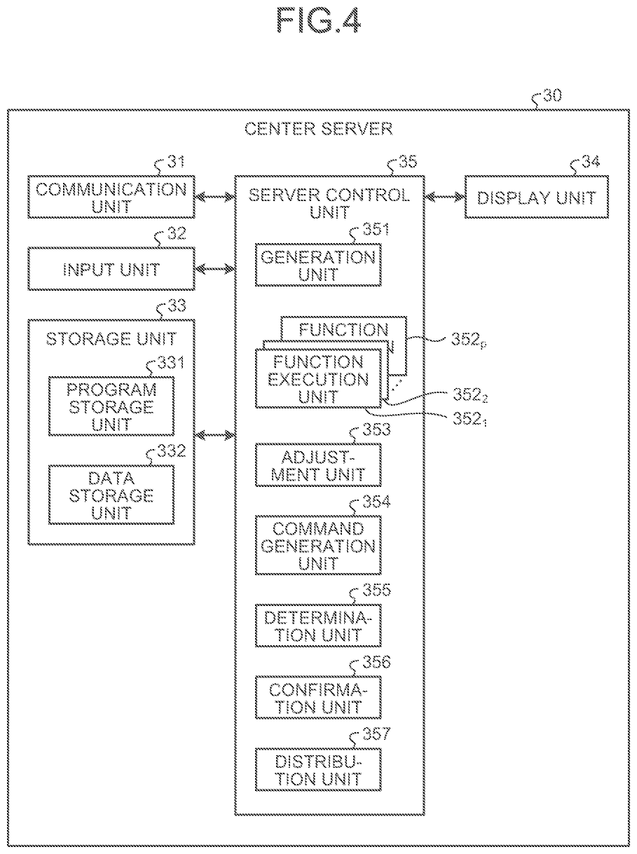

Next, a functional configuration of the center server 30 will be described. FIG. 4 is a block diagram illustrating a functional configuration of the center server 30. The center server 30 illustrated in FIG. 4 includes a communication unit 31, an input unit 32, a storage unit 33, a display unit 34, and a server control unit 35. In the embodiment, the center server 30 functions as a server.

Under the control of the server control unit 35, the communication unit 31 sends various types of information to the vehicle 10 or the edge server 20 according to a predetermined communication standard via the base station 40 and the network 50 or the network 60. Furthermore, the communication unit 31 receives various types of information from the vehicle 10 or the edge server 20 according to a predetermined communication standard via the base station 40 and the network 50 or the network 60. The communication unit 31 includes a communication module capable of wireless communication or the like.

The input unit 32 includes a keyboard, a touch panel, a mouse, or the like. The input unit 32 receives inputs of various operations from a user, and outputs information corresponding to the received input various operations to the server control unit 35.

The storage unit 33 includes a recording medium such as a ROM, a RAM, an HDD, or an SSD. The storage unit 33 includes a program storage unit 331 that stores various programs executed by the center server 30 and a data storage unit 332 that stores various type of data being processed by the center server 30.

The display unit 34 includes a display panel such as a liquid crystal or organic EL display. The display unit 34 displays various types of information under the control of the server control unit 35.

The server control unit 35 includes a memory and a processor having hardware such as a CPU. The server control unit 35 controls each unit included in the center server 30. The server control unit 35 includes a generation unit 351, function execution units 352₁ to 352ₚ (p=an integer of 3 or more) (hereinafter, when any one of the function execution units 352₁ to 352ₚ is referred to, it is simply referred to as the “function execution unit 352”), an adjustment unit 353, a command generation unit 354, a determination unit 355, a confirmation unit 356, and a distribution unit 357.

The generation unit 351 generates vehicle condition information as publish data including a topic based on broadcast data input by the operator operating the input unit 32, and outputs the vehicle condition information to at least one of the distribution unit 357 or the function execution unit 352.

Each of the function execution units 352₁ to 352ₚ provides various services by executing each of a plurality of application programs stored in the program storage unit 331. The number of the plurality of function execution units 352 can be appropriately changed according to the number of pieces of application software stored in the program storage unit 331.

The adjustment unit 353 performs adjustment by deleting control command information that is superimposed in the plurality of pieces of control command information input from respective ones of the plurality of function execution units 352, and outputs the control command information to the command generation unit 354. In addition, when the adjustment unit 353 causes the respective function execution units 352₁ to 352ₚ that execute a plurality of applications to extract and output a partially overlapped data part between pieces of desired data for the plurality of applications, the adjustment unit 353 causes output of the partially overlapped data part in association with first application information related to a representative application among the plurality of applications in cooperation with the determination of the determination unit 355.

The command generation unit 354 generates control command information to be distributed to the vehicle 10 based on the plurality of pieces of adjusted control command information input from the adjustment unit 353, and outputs the control command information to the distribution unit 357.

The determination unit 355 determines whether respective pieces of desired data for a plurality of applications executed by the respective function execution units 352₁ to 352ₚ are partially overlapped with each other, and output the determination result to the adjustment unit 353.

The confirmation unit 356 outputs, to the command generation unit 354, re-sending request command information (request to send valid commands again) for requesting resending (re-output) of the control command information output from the command generation unit 354 to the vehicle 10 immediately before the vehicle 10 is switched to the offline state based on the communication state information of the vehicle 10 input via the distribution unit 357.

The distribution unit 357 outputs the re-sending request command information to the plurality of vehicles 10₁ to 10ₙ based on the vehicle condition information input from the generation unit 351.

Outline of Each Type of Processing in Data Collection System

Next, an outline of processing executed by the data collection system 1 will be described. Note that a case where the data collection system 1 uses the Publish/Subscribe message model will be described below.

Outline of Distribution Processing to All Vehicles 10

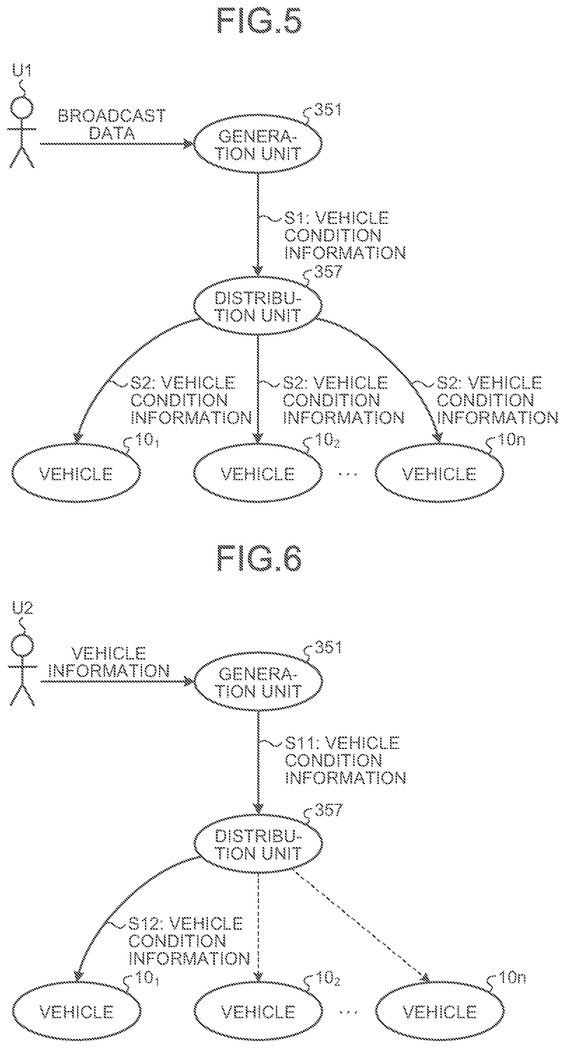

First, an outline of processing performed by the center server 30 to distribute the vehicle condition information to all the vehicles 10 (Subscribe) will be described. FIG. 5 is a diagram illustrating an outline of distribution processing performed by the center server 30 to distribute the vehicle condition information to all the vehicles 10.

As illustrated in FIG. 5, first, in the center server 30, the generation unit 351 generates vehicle condition information (for example, Publish topic:/jit/addr/all data) based on the broadcast data input from an operator U1 via the input unit 32, and outputs the vehicle condition information to the distribution unit 357 functioning as MQTT_Broker (step S1).

Subsequently, in the center server 30, the distribution unit 357 distributes (sends), to all the vehicles 10₁ to 10ₙ, the vehicle condition information (Subscribe topic://jit/addr/all data) input from the generation unit 351 (step S2). In this case, the distribution unit 357 distributes the vehicle condition information only to the vehicles 10₁ to 10ₙ that have applied for distribution of a topic distributed by the center server 30.

In this manner, the center server 30 can distribute the vehicle condition information to all the vehicles 10₁ to 10ₙ.

Outline of Distribution Processing to Vehicle Meeting Specific Condition

Next, an outline of processing performed by the center server 30 to distribute the vehicle condition information to the vehicle 10 meeting a specific condition will be described. FIG. 6 is a diagram illustrating an outline of distribution processing performed by the center server 30 to distribute the vehicle condition information to the vehicle 10 that meets a specific condition.

As illustrated in FIG. 6, first, in the center server 30, the generation unit 351 generates vehicle condition information (for example, Publish topic:/jit/addr/all data) based on specific vehicle information (Vieclel data) input from an operator U2 via the input unit 32, and outputs the vehicle condition information to the distribution unit 357 functioning as MQTT_Broker (step S11).

Subsequently, in the center server 30, the distribution unit 357 distributes, to the vehicle 10₁ meeting the predetermined condition, the vehicle condition information (Subscribe topic://jit/addr/all data) input from the generation unit 351 (step S12).

In this manner, the center server 30 can send the vehicle condition information to the vehicle 10₁ meeting the predetermined condition (matching vehicle).

Outline of Distribution Processing of Control Command Information

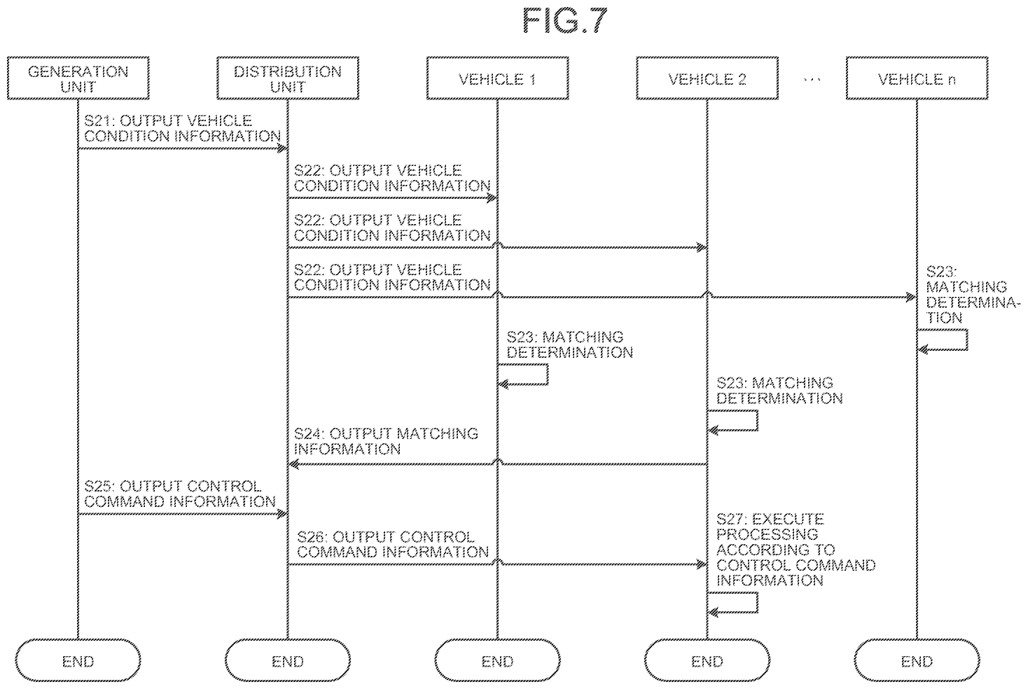

Next, an outline of distribution processing performed by the center server 30 to distribute the control command information to the vehicle 10 that matches the vehicle condition information will be described. FIG. 7 is a diagram illustrating an outline of distribution processing performed by the center server 30 to distribute the control command information to the vehicle 10 that matches the vehicle condition information.

As illustrated in FIG. 7, first, in the center server 30, the generation unit 351 generates vehicle condition information (for example, topic:/jit/addr/all if condition is true then Subscribe/jit/addr/multi/1) based on the broadcast data input from an operator U1 via the input unit 32, and outputs the vehicle condition information to the distribution unit 357 functioning as MQTT_Broker (step S21).

Subsequently, in the center server 30, the distribution unit 357 distributes (sends), to all the vehicles 10₁ to 10ₙ, the vehicle condition information (for example, topic:/jit/addr/all if condition is true then Subscribe/jit/addr/multi/1) input from the generation unit 351 (step S22). In this case, the distribution unit 357 distributes the vehicle condition information only to all the vehicles 10₁ to 10_{N} that have applied for distribution of a topic distributed by the center server 30.

Thereafter, each of the vehicle 10₁ to the vehicle 10_{N} determines whether the vehicle matches the vehicle condition information distributed from the distribution unit 357 of the center server 30 (step S23), and the vehicle 102 sends matching information (for example, Subscribe/jit/addr/multi/1) indicating that the vehicle matches the vehicle condition information to the center server 30 (step S24).

Subsequently, the center server 30 outputs, to the distribution unit 357, the control command information (for example, topic:/jit/addr/multi/1 data) for causing the generation unit 351 to extract desired data from the vehicle 102 matching the vehicle condition information (step S25).

Thereafter, in the center server 30, the distribution unit 357 distributes, to the vehicle 102 matching the vehicle condition information, the control command information (for example, topic:/jit/addr/multi/1 data) input from the generation unit 351 (step S26).

Subsequently, the vehicle 102 executes processing according to the control command information output from the center server 30 (step S27). In this case, when the control command information includes a command to extract predetermined data and output the data to the center server 30, the vehicle 102 extracts data corresponding to the control command information from the data stored in the data storage unit 132 and outputs the data to the center server 30. Here, the predetermined data is, for example, current position information, vehicle speed information, and state information regarding the state of the host vehicle regarding the vehicle 102, and moving image data within a predetermined time specified by the operator U1 or the like.

As described above, the center server 30 can cause the vehicle 10 that matches the vehicle condition information input by the operator U1 from among the plurality of vehicles 10₁ to 10ₙ to execute the desired processing specified by the operator U1 by distributing (outputting) the control command information to the vehicle 10.

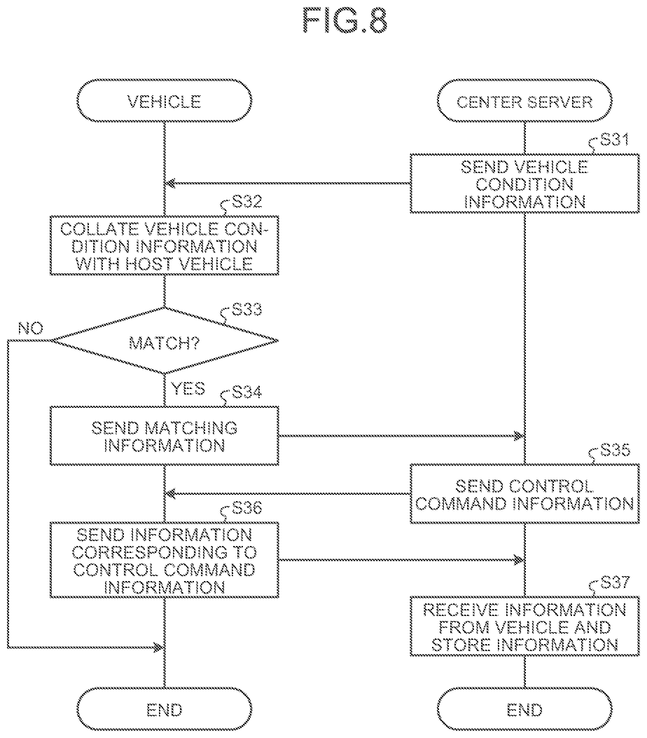

Processing of Data Collection System Next, processing executed by the data collection system 1 will be described. FIG. 8 is a flowchart illustrating an outline of processing executed by the data collection system 1. Note that, in the description below, a flow of processing for one vehicle 10 will be described in order to simplify the description, but similar processing is performed for the vehicles 10₁ to 10ₙ as described with reference to FIGS. 5 to 7.

As illustrated in FIG. 8, the center server 30 sends, to the vehicle 10, the vehicle condition information generated based on the specific vehicle information input from the operator U1 (step S31). In this case, the center server 30 distributes the vehicle condition information to the vehicle 10 that has applied for distribution of a topic distributed by the center server 30.

Subsequently, the vehicle 10 collates the vehicle condition information sent from the center server 30 with the host vehicle (step S32), and determines whether the host vehicle matches the vehicle condition information (step S33). Specifically, the ECU 17 of the vehicle 10 collates the host vehicle information of the host vehicle stored in the data storage unit 132 with the vehicle condition information sent from the center server 30, and determines whether the host vehicle matches the vehicle condition information. For example, the ECU 17 of the vehicle 10 determines whether the vehicle type included in the host vehicle information of the host vehicle stored in the data storage unit 132 matches the vehicle type included in the vehicle condition information. Further, when the vehicle condition information includes, in addition to the vehicle type, the position information included in the vehicle condition information, the ECU 17 of the vehicle 10 may determine whether the position information of the host vehicle included in the host vehicle information of the host vehicle stored in the data storage unit 132 matches the position information included in the vehicle condition information. Of course, the ECU 17 of the vehicle 10 determines whether the host vehicle information matches the vehicle condition information output from the center server 30 regarding all the items included in the vehicle condition information (for example, vehicle type information, model information, and the like). When the vehicle 10 determining that the host vehicle matches the vehicle condition information (step S33: Yes), the vehicle 10 proceeds to step S34. On the other hand, when the vehicle 10 determines that the host vehicle does not match the vehicle condition information (step S33: No), the vehicle 10 ends this processing.

In step S34, the vehicle 10 sends matching information indicating that the host vehicle matches the vehicle condition information to the center server 30.

Subsequently, based on the matching information sent from the vehicle 10, the center server 30 sends the control command information to the vehicle 10 matching the vehicle condition information (step S35).

Thereafter, the vehicle 10 sends information corresponding to the control command information received from the center server 30 to the center server 30 (step S36). For example, the vehicle 10 sends information obtained by extracting data corresponding to the control command information to the center server 30. Specifically, when the control command information includes a command to extract and output moving image data captured in a predetermined traveling section at predetermined time intervals, the vehicle 10 extracts moving image data captured in the predetermined traveling section from the moving image data stored in the data storage unit 132 at predetermined time intervals, and sends the extracted moving image data to the center server 30. The control command information also includes a control command to be executed by the vehicle 10, and the like. For example, the control command information includes a control command for causing sending of acceleration information of the vehicle 10 every 3 minutes to the center server 30, a control command for causing output of image data or moving image data captured by the camera 12 every 1 hour to the center server 30, a control command for causing execution of a predetermined program stored in the program storage unit 131 of the vehicle 10, and the like. After step S36, the vehicle 10 ends this processing.

Subsequently, the center server 30 receives information from the vehicle 10 and stores the information in the storage unit 33 (step S37). After step S37, the center server 30 ends the processing.

Distribution Processing from Plurality of Services to Vehicle

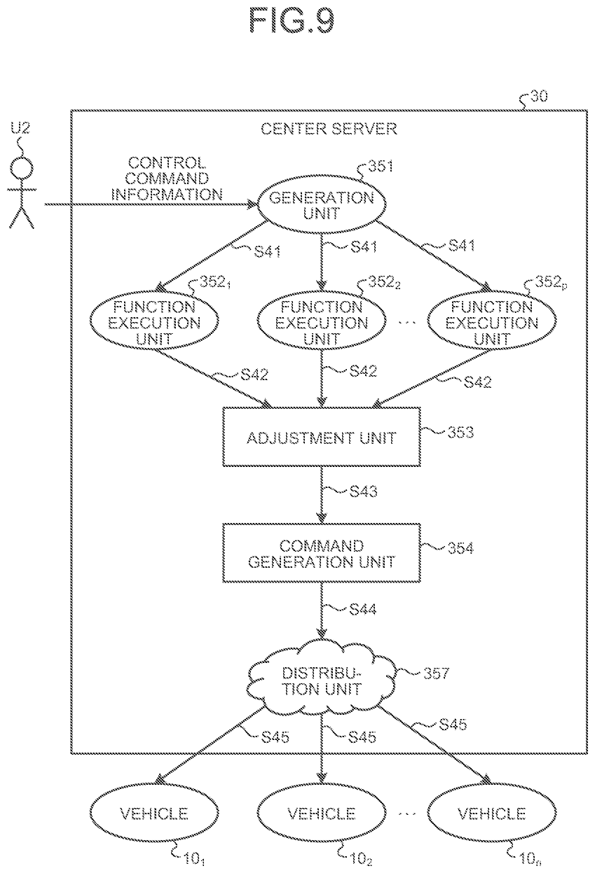

Next, distribution processing performed by the center server 30 to distribute, to the vehicles 10₁ to 10ₙ, pieces of control command information from a plurality of services will be described. First, a flow of distribution processing for distributing the control command information from the center server 30 to the vehicles 10₁ to 10ₙ will be described. FIG. 9 illustrates an outline of distribution processing performed by the center server 30 to distribute, to the plurality of vehicles 10₁ to 10ₙ, the pieces of control command information from a plurality of services.

As illustrated in FIG. 9, first, in the center server 30, the generation unit 351 outputs the control command information based on an operation of the operator U1 input via the input unit 32 to the function execution units 352₁ to 352ₚ each of which performs a service according to an application using the data of the vehicle 10 (step S41).

Subsequently, each of the function execution units 352₁ to 352ₚ generates a control command (command) corresponding to its own service and outputs the control command to the adjustment unit 353 functioning as a command manager (step S42).

Thereafter, the adjustment unit 353 adjusts overlapped commands among the plurality of commands output from the respective function execution units 352₁ to 352ₚ, and outputs the adjusted commands to the command generation unit 354 functioning as a communication manager (step S43).

Subsequently, the command generation unit 354 outputs the control command information, which is obtained by converting the plurality of adjusted commands from the adjustment unit 353 into a predetermined format and packaging the converted commands, to the distribution unit 357 functioning as MQTT_Broker (step S44).

Thereafter, the distribution unit 357 distributes (sends) the control command information obtained by the packaging by the command generation unit 354 to the vehicles 10₁ to 10ₙ (step S45).

As described above, the center server 30 can distribute, to the vehicles 10₁ to 10ₙ, the pieces of control command information corresponding to respective ones of the plurality of services corresponding to the plurality of applications that the center server 30 provides.

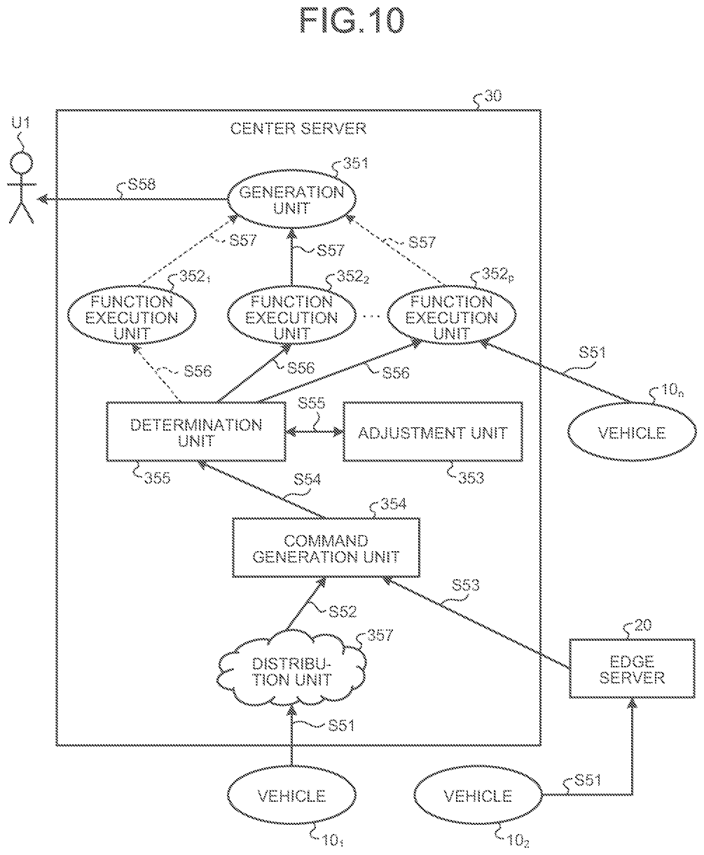

Next, a flow of data processing from each of the vehicle 10₁ to the vehicle 10ₙ to the generation unit 351 of the center server 30 will be described. FIG. 10 is a diagram illustrating an outline of data processing from each of the vehicle 10₁ to the vehicle 10ₙ to the generation unit 351 of the center server 30.

As illustrated in FIG. 10, each of the vehicle 10₁ to the vehicle 10ₙ sends data to the function execution unit 352 via any one of the distribution unit 357, the edge server 20, and the center server 30 according to the communication level of the communication status or the data type (step S51). For example, in a case where the data type is moving image data, when the control command information from the center server 30 includes a control command of image processing of detecting a subject from the moving image data, the vehicle 102 outputs the specified moving image data to the edge server 20 in response to the control command in order to cause the edge server 20 to execute the image processing of detecting the subject in place of the ECU 17. In addition, in a case where the data type is moving image data, the vehicle 10ₙ selects a communication line network at a communication level capable of outputting the moving image data from among a plurality of communication line networks and sends the moving image data to the center server 30.

Subsequently, the distribution unit 357 outputs data output from the vehicle 10₁ to the command generation unit 354 (step S52), and the edge server 20 sends the data output from the vehicle 102 to the command generation unit 354 of the center server 30 (step S53). In this case, the edge server 20 outputs the data after performing processing that would cause a high load on the vehicle 102 to the command generation unit 354. For example, in a case where the control command information from the center server 30 includes a control command for causing output of a detection result of detecting a subject or an object appearing in the moving image data, the edge server 20 performs detection processing of detecting a subject or an object appearing in the moving image data in place of the vehicle 102, and sends the detection result and the moving image data to the command generation unit 354 in association with each other.

Thereafter, the command generation unit 354 outputs the data output from the distribution unit 357 or the edge server 20 to the determination unit 355 (step S54). In this case, the command generation unit 354 converts data in a predetermined communication format into a format that can be processed in the center server 30 and outputs the converted data to the determination unit 355.

Subsequently, the determination unit 355 determines whether the function execution units 352₁ to 352ₚ that execute the respective ones of the plurality of applications execute the applications using pieces of desired data that are partially overlapped with each other based on the plurality of pieces of data output from the command generation unit 354 and output the determination result to the adjustment unit 353 (step S55).

Thereafter, when the adjustment unit 353 causes the respective function execution units 352₁ to 352ₚ that execute a plurality of applications to extract and output a partially overlapped data part between pieces of desired data for the plurality of applications, the adjustment unit 353 causes output of the partially overlapped data part in association with first application information related to a representative application among the plurality of applications in cooperation with the determination unit 355 (step S56). In this case, the determination unit 355 determines whether respective pieces of desired data for a plurality of applications executed by the respective function execution units 352₁ to 352ₚ are partially overlapped with each other, and output the determination result to the adjustment unit 353. Based on the determination result of the determination unit 355, the adjustment unit 353 further outputs second application information related to another application and the metadata of the partially overlapped data part in association with each other. Here, the partially overlapped data part between the pieces of desired data for the respective ones of the plurality of applications is, for example, moving image data or cache stored for each application in the storage unit 33 of the center server 30, and is data of a time that is overlapped. The metadata includes at least the representative image (for example, a thumbnail image) of moving image data and time information indicating the time of the section of partially overlapped part between pieces of moving image data. Thus, the amount of useless data can be reduced.

Subsequently, each of the function execution units 352₁ to 352ₚ outputs data of a service corresponding to the application to the generation unit 351 (step S57).

Thereafter, the generation unit 351 causes the display unit 34 to display data according to the control command information input according to the operation of the operator U1 (step S58).

In this manner, data desired by the operator U1 can be extracted for each of services corresponding to the plurality of applications.

Processing in Reconnection

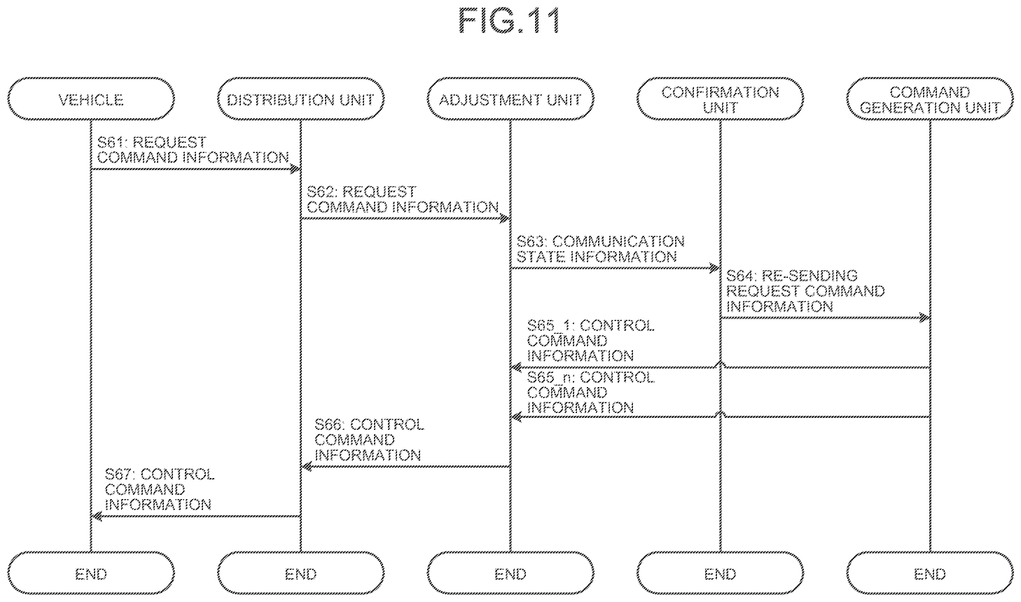

Next, in a case where the control command information is sent from the center server 30 to the vehicle 10, a flow of data processing performed when the communication state of the vehicle 10 is switched from the online state to the offline state, and then switched back to the online state will be described. FIG. 11 is a diagram illustrating an outline of data processing performed when the communication state of the vehicle 10 is switched from the online state to the offline state and then switched back to the online state.

As illustrated in FIG. 11, when the communication state changes from the offline state to the online state, the ECU 17 of the vehicle 10 sends request command information for requesting sending of the control command information to the distribution unit 357 of the center server 30 again (step S61). Specifically, the ECU 17 of the vehicle 10 outputs, to the distribution unit 357, the request command information including the number of the command executed immediately before the vehicle 10 is switched to the offline state (Publish topic for reconnection with last sequence number).

Subsequently, the distribution unit 357 outputs, to the adjustment unit 353 that functions as the communication manager, the request command information output from the vehicle 10 (step S62).

Thereafter, the adjustment unit 353 generates communication state information indicating the communication state of the vehicle 10 (target state management) based on the request command information output from the distribution unit 357 and outputs the communication state information to the confirmation unit 356 functioning as a target manager (step S63).

Thereafter, the confirmation unit 356 outputs, to the command generation unit 354, a re-sending request command information (request to send valid commands again) for requesting resending (re-output) of the control command information output from the command generation unit 354 to the vehicle 10 immediately before the vehicle 10 is switched to the offline state based on the communication state information (step S64).

Subsequently, the command generation unit 354 outputs the control command information of a predetermined number of times (for example, command N, command n+1) to the adjustment unit 353 based on the re-sending request command information (step S65_1, step S65_N+1).

Thereafter, the adjustment unit 353 outputs, to the distribution unit 357, control command information (Publish valid commands after off-line) output by the command generation unit 354, which has not been executed until immediately before the vehicle 10 is switched to the offline state (step S66).

Subsequently, the distribution unit 357 sends the control command information input from the adjustment unit 353 to the vehicle 10, the communication state of which has switched back to the online state (step S67).

As described above, when the communication state of the vehicle 10 is switched back to the online state from the offline state, the center server 30 can send the control command information again in response to a request command signal from the vehicle 10 even if the control command information is output immediately before the switching to the offline state.

According to the embodiment described above, the server control unit 35 outputs the vehicle condition information to one or more target vehicles to be subjected to data collection based on any condition, and outputs control command information for causing a matching vehicle that matches the vehicle condition information from among the one or more target vehicles to execute predetermined processing. Thus, it is possible to flexibly cope with diversification of services to be provided.

In addition, according to the embodiment, the server control unit 35 specifies the target vehicle to which the vehicle condition information is to be output from among the vehicles 10₁ to 10ₙ and outputs the vehicle condition information to the target vehicle, so that it is possible to suppress useless sending traffic.

According to the embodiment, the control command information includes a control command for causing extraction and output of desired data from at least the matching vehicle, so that it is possible to efficiently extract and collect data desired by the operator U1.

Furthermore, according to the embodiment, in a case where the target vehicle executes a plurality of applications using pieces of data that are partially overlapped with each other, and the server control unit 35 causes extraction and output of the partially overlapped data part between the pieces of desired data for the plurality of applications, the server control unit 35 causes output of the partially overlapped data part in association with first application information related to a representative application among the plurality of applications, and causes output of second application information related to another application and metadata of the partially overlapped data part in association with each other. Thus, it is possible to prevent the same data from being stored in an overlapped manner, and thus, it is possible to suppress the traffic amount.

Furthermore, according to the embodiment, the partially overlapped data part is moving image data, the metadata includes at least the time information indicating the time of the partially overlapped data part in the moving image data, and only the minimum data amount is sent, so that the traffic amount of sending from the vehicle 10 to the center server 30 can be suppressed.

In addition, according to the embodiment, in a case where after the server control unit 35 outputs the control command information, the communication state of the matching vehicle is switched to the offline state, when the communication state is switched back to the online state and the server control unit 35 acquires, from the matching vehicle, the request command information for requesting re-output of the control command information, the server control unit 35 outputs the control command information. Thus, even while the control command information is being sent from the center server 30 to the matching vehicle, it is possible to cause execution of processing desired by the operator U1 at the timing when the communication state of the matching vehicle is switched back to the online state.

According to the embodiment, the vehicle condition information includes at least one of vehicle type information, model information, or position information of a target vehicle, target collection data, or data format, so that the target vehicle desired by the operator U1 can easily be selected from the vehicles 10₁ to 10ₙ.

In the embodiment, the server control unit 35 includes each of the generation unit 351, the function execution unit 352, the adjustment unit 353, the command generation unit 354, the determination unit 355, the confirmation unit 356, and the distribution unit 357. However, for example, each component may be implemented to function on a server implemented by cloud computing or the like. Of course, the functions of the generation unit 351, the function execution unit 352, the adjustment unit 353, the command generation unit 354, the determination unit 355, the confirmation unit 356, and the distribution unit 357 may be included in the edge server 20.

In addition, in the data collection system according to the embodiment, a “unit” can be replaced with a “circuit” or the like. For example, the server control unit can be replaced with a server control circuit.

In addition, the program to be executed by the data collection system according to the embodiment is file data in a format allowing for installation or execution, and is provided being recorded in a computer-readable recording medium such as a CD-ROM, a flexible disk (FD), a CD-R, a digital versatile disk (DVD), a USB medium, or a flash memory.

In addition, the program to be executed by the data collection system according to the embodiment may be stored on a computer connected to a network such as the Internet and provided by being downloaded via the network.

Note that, in the description of the flowcharts in the present specification, the order of pieces of processing of steps is clearly indicated using expressions such as “first”, “thereafter”, and “subsequently”, but the order of the pieces of processing required to implement the present embodiment is not uniquely determined by these expressions. That is, the order of pieces of processing in the flowcharts described in the present specification can be changed within a range that does not cause inconsistency.

The present disclosure has an effect of flexibly coping with diversification of services to be provided.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising a processor configured to:
generate vehicle condition information for one or more target vehicles to be subjected to data collection based on any condition; and
output control command information for causing a matching vehicle that matches the vehicle condition information among the one or more target vehicles to execute predetermined processing.

2. The server according to claim 1, wherein
the control command information includes a control command for causing extraction and output of desired data from at least the matching vehicle.

3. The server according to claim 2, wherein
the processor is further configured to:
in a case where the target vehicle executes a plurality of applications using pieces of partially overlapped data that are partially overlapped with each other, and the processor causes extraction and output of the partially overlapped data part between pieces of desired data for each of the plurality of applications,
cause output of the partially overlapped data part in association with first application information related to a representative application among the plurality of applications, and cause output of second application information related to another application in association with metadata of the partially overlapped data part.

4. The server according to claim 3, wherein
the partially overlapped data part is moving image data, and
the metadata includes at least time information indicating a time of the partially overlapped data part in the moving image data.

5. The server according to claim 1, wherein
the processor is further configured to output the control command information, in a case where after output of the control command information and a communication state of the matching vehicle is switched to an offline state and when the communication state is switched back to an online state and the processor acquires a request command information for requesting re-output of the control command information from the matching vehicle.

6. The server according to claim 1, wherein
the vehicle condition information includes at least one of vehicle type information, model information, and position information of the target vehicle, target collection data, and a data format.

7. A data collection system comprising:
a plurality of vehicles each including a sensor group for detecting vehicle data related to at least a vehicle state; and
a server including a processor configured to generate vehicle condition information for one or more target vehicles to be subjected to data collection based on any condition; and output control command information for causing a matching vehicle that matches the vehicle condition information among the one or more target vehicles to execute predetermined processing.

8. The data collection system according to claim 7, wherein
each of the plurality of vehicles determines whether the host vehicle matches the vehicle condition information, and when the host vehicle matches the vehicle condition information, outputs matching information indicating that the host vehicle matches the vehicle condition information to the server.

9. The data collection system according to claim 8 further comprising
an edge server that performs predetermined image processing on data input from the matching vehicle and outputs the data to the server, wherein
the control command information includes at least a control command for causing extraction and output of desired data from the matching vehicle, and
the matching vehicle extracts and outputs desired data to the edge server in response to the control command information.

10. A non-transitory computer-readable recording medium storing a program that causes a processor to:
generate vehicle condition information for one or more target vehicles to be subjected to data collection based on any condition; and
output control command information for causing a matching vehicle that matches the vehicle condition information among the one or more target vehicles to execute predetermined processing.

11. A data collection method performed by a processor, comprising:
generating vehicle condition information for one or more target vehicles to be subjected to data collection based on any condition; and
outputting control command information for causing a matching vehicle that matches the vehicle condition information among the one or more target vehicles to execute predetermined processing.
